(19) United States
(12) Patent Application Publication
(10) Pub. No.: US 2020/0050783 A1
(43) Pub. Date: Feb. 13, 2020

(54) INFORMATION PROCESSING DEVICE AND COMPUTER READABLE MEDIUM

(71) Applicant: Mitsubishi Electric Corporation, Tokyo (JP)

(72) Inventors: Tatsuya YAMADA, Tokyo (JP); Takehisa MIZUGUCHI, Tokyo (JP); Hirotaka MOTAI, Tokyo (JP); Yurika TAKAHASHI, Tokyo (JP); Tetsuji FUJISAKI, Tokyo (JP)

(73) Assignee: Mitsubishi Electric Corporation, Tokyo (JP)

(21) Appl. No.: 16/475,460

(22) PCT Filed: Mar. 2, 2017
(86) PCT No.: PCT/JP2017/008298

§ 371 Date: Jul. 2, 2019

(51) Int. Cl. G06F 21/62; G06F 21/60; H04L 29/06; G06F 12/14; G06F 9/455

(52) U.S. Cl. CPC G06F 21/6218; G06F 21/604; H04L 63/101; G06F 2009/45583; G06F 9/45558; G06F 2221/2141; G06F 12/1483

(57) ABSTRACT

A table determination unit performs a table determination process, when an access request occurs, of determining presence/absence of access authority by referring to an authority table. A code determination unit performs a code determination process, when the access request occurs, of determining presence/absence of the access authority by executing a determination code to determine presence/absence of the access authority. An access control unit allows access in a case where it is determined by the table determination process that the access authority is present and it is determined by the code determination process that the access authority is present.

### TECHNICAL FIELD

The present invention relates to access management for system resources.

### BACKGROUND ART

In general, a hypervisor and an operating system (OS) can exclusively allocate a memory resource to each guest OS and each process. Since an assignment management table is often arranged in a random access memory (RAM), if read/write across the boundary of an allocated area occurs, there is a possibility that data may be rewritten. Therefore, the management table has to be protected.

Patent Literature 1 proposes a boundary detection method related to memory protection for exclusively allocating a memory resource. In this method, an attribute table and a table which indicates access authority are used to determine an accessible area.

Patent Literature 2 proposes a method of determining an accessible area. With this method, authority information is not managed by a table, and a determination expression is embedded in an execution code of a program.

Patent Literature 3 proposes a method of dividing a management table according to the type of area corresponding to access authority.

### CITATION LIST

### Patent Literature

Patent Literature 1: Japanese Patent No. 3607540

Patent Literature 2: Japanese Patent No. 5893038

Patent Literature 3: Japanese Patent No. 4939387

### Summary of Invention

### Technical Problem

A management table in which authority information is stored is called an authority table.

The authority table is arranged in a RAM when a hypervisor or an OS is operating. Therefore, there is a possibility that the authority information can be rewritten by an attack that rewrites a memory area, such as a row hammer attack and a buffer overflow attack. When the authority information is rewritten, a memory area allocated to a guest OS or application becomes invalid, and another area is rewritten by a program not having authority.

With a conventional method, an area whose access authority is given by the authority table is protected. However, the authority table itself cannot be protected.

Further, with a method in which a determination code of access authority is inserted into an execution program, it is possible to check the validity of the own access authority. However, access violation by another execution subject cannot be detected.

Furthermore, it is possible to distribute the targets of a rewrite attack by a method of dividing an authority table according to a role and separating a part that may be changed from the other parts. However, since each authorization table has only an original role, it cannot cope with memory rewriting.

As a simple countermeasure against rewriting of the authority table, a method of providing the authority table with redundancy by multiplexing the authority table may be possible.

However, even if the authority table is multiplexed, each authority table is arranged as data in the RAM, so an attack on the memory area by the conventional attack method is possible. Also, since data is arranged concentratedly in a specific area by a compiler, a focused attack on the specific area is possible.

It is an objective of the present invention to enable access management correctly even if an authority table is falsified.

### Solution to Problem

An information processing device according to the present invention includes:

a table determination unit to perform a table determination process, when an access request for a system resource occurs, of determining presence/absence of access authority by referring to an authority table including authority information to identify presence/absence of the access authority for the system resource;

a code determination unit to perform a code determination process, when the access request occurs, of determining presence/absence of the access authority by executing a determination code to determine presence/absence of the access authority; and

an access control unit to allow access to the system resource in a case where it is determined by the table determination process that the access authority is present and it is determined by the code determination process that the access authority is present.

### Advantageous Effects of Invention

According to the present invention, even if it is determined by a table determination process that access authority is present, access is not allowed unless presence of the access authority is determined by a code determination process.

Therefore, access management can be performed correctly even if an authority table is falsified.

### BRIEF DESCRIPTION OF DRAWINGS

FIG. 1 is a configuration diagram of an information processing device 100 in Embodiment 1.

FIG. 2 is a configuration diagram of a processor 101 in Embodiment 1.

FIG. 3 is a configuration diagram of a memory 102 in Embodiment 1.

FIG. 4 is a configuration diagram of an authority table 115 in Embodiment 1.

FIG. 5 is a configuration diagram of a determination code 116.

FIG. 6 is a flowchart of an access management method in Embodiment 1.

FIG. 7 is a diagram illustrating the authority table 115 after falsification.

FIG. 8 is a configuration diagram of a processor 101 in Embodiment 2.

FIG. 9 is a configuration diagram of a memory 102 in Embodiment 2.

FIG. 10 is a configuration diagram of an authority table 115 in Embodiment 2.

FIG. 11 is a configuration diagram of a determination code 116 in Embodiment 2.

FIG. 12 is a configuration diagram of a processor 101 in Embodiment 3.

FIG. 13 is a configuration diagram of a memory 102 in Embodiment 3.

FIG. 14 is a configuration diagram of an authority table 115 in Embodiment 3.

FIG. 15 is a configuration diagram of a determination code 116 in Embodiment 3.

FIG. 16 is a flowchart of update processing in Embodiment 3.

FIG. 17 is a diagram illustrating a code format 152 in Embodiment 3.

FIG. 18 is a configuration diagram of a processor 101 in Embodiment 4.

FIG. 19 is a configuration diagram of a memory 102 in Embodiment 4.

FIG. 20 is a flowchart of an access management method in Embodiment 4.

FIG. 21 is a flowchart of the access management method in Embodiment 4.

FIG. 22 is a hardware configuration diagram of the information processing device 100 in the embodiments.

### DESCRIPTION OF EMBODIMENTS

In embodiments and drawings, the same reference numeral denotes the same or equivalent embodiments. Descriptions of the elements denoted by the same reference numeral will be omitted or simplified appropriately. Arrows in the drawings mainly indicate flows of data or flows of processing.

### Embodiment 1

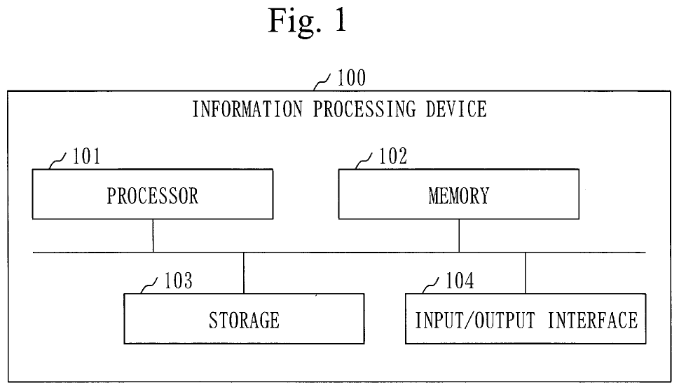

An embodiment in which access management for system resources is performed will be described referring to FIGS. 1 to 7.

### Description of Configuration

A configuration of an information processing device 100 will be described referring to FIG. 1.

The information processing device 100 is a computer provided with hardware devices such as a processor 101, a memory 102, a storage 103, and an input/output interface 104. These hardware devices are connected to each other via signal lines.

The processor 101 is an arithmetic computation device that performs various types of information processing operations while controlling the memory 102, the storage 103, and the input/output interface 104. For example, the processor 101 is a central processing unit (CPU).

The memory 102 is a volatile storage device. For example, the memory 102 is a random access memory (RAM). Data stored in the memory 102 is saved in the storage 103 where necessary.

The storage 103 is a non-volatile storage device. For example, the storage 103 is a read only memory (ROM), a hard disk drive (HDD), or a flash memory. Data stored in the storage 103 is loaded to the memory 102 where necessary.

The input/output interface 104 is an interface to which an input device and an output device are connected. For example, the input/output interface 104 includes USB terminals, the input device includes a keyboard and a mouse, and the output device includes a display. USB is an abbreviation for universal serial bus.

The information processing device 100 may be provided with a plurality of processors that replace the processor 101. The plurality of processors share the role of the processor 101.

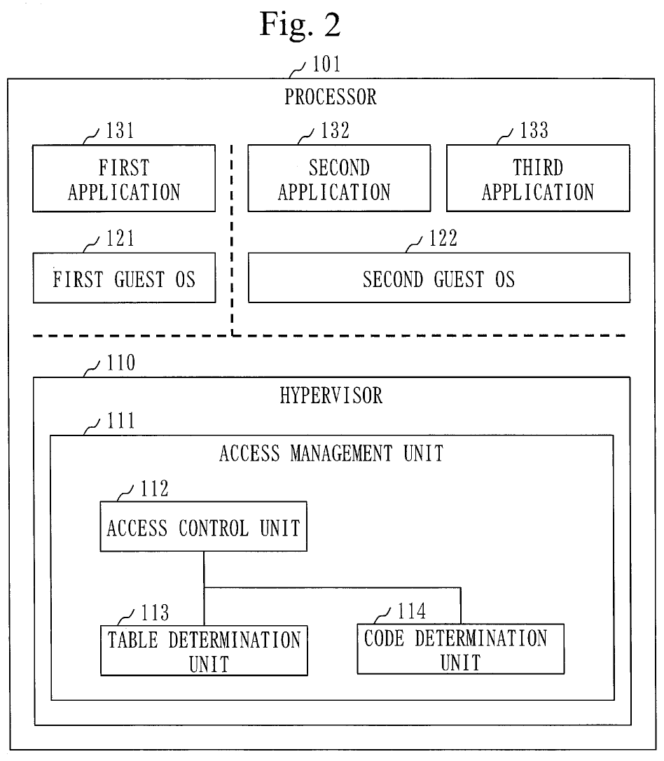

A configuration of the processor 101 will be described referring to FIG. 2.

The processor 101 executes a hypervisor 110, a plurality of guest OSs (121, 122), and a plurality of applications (131, 132, 133). The applications signify application programs.

The hypervisor 110 controls the plurality of guest OSs. More specifically, the hypervisor 110 allocates hardware resources of the information processing device 100 to each of a first guest OS 121 and a second guest OS 122.

The first guest OS 121 is executed by using the hardware resource allocated by the hypervisor 110.

A first application 131 is executed by using the hardware resource allocated to the first guest OS 121.

The second guest OS 122 is executed by using the hardware resource allocated by the hypervisor 110.

A second application 132 is executed by using the hardware resource allocated to the second guest OS 122.

A third application 133 is executed by using the hardware resource allocated to the second guest OS 122.

The processor 101 serves as an access management unit 111 by executing the hypervisor 110.

The access management unit 111 is provided with an access control unit 112, a table determination unit 113, and a code determination unit 114.

Each function of the access control unit 112, table determination unit 113, and code determination unit 114 will be described later.

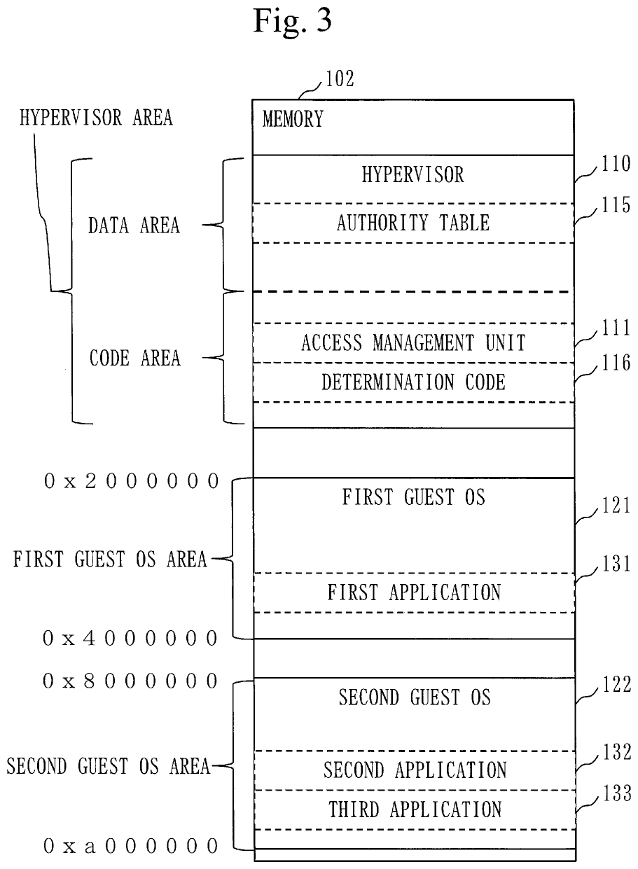

A configuration of the memory 102 will be described referring to FIG. 3.

The memory 102 has a hypervisor area, a first guest OS area, and a second guest OS area.

The hypervisor area is a memory area for the hypervisor 110.

The first guest OS area is a memory area for the first guest OS 121.

The second guest OS area is a memory area for the second guest OS 122.

The hypervisor area has a data area and a code area.

The data area is a memory area where data is arranged.

In the data area, an authority table 115 and so on are arranged.

The code area is a memory area where an execution code is arranged. The execution code is a program created in such a format that it can be executed by the processor 101.

In the code area, the access management unit 111, a determination code 116, and so on are arranged.

The authority table 115 is a table containing authority information.

The authority information is information for identifying presence/absence of access authority for system resources. The system resources signify the hardware resources, particularly a memory area, of the information processing device 100.

The determination code 116 is an execution code for determining presence/absence of access authority for the system resources.

The first guest OS area is an address space ranging from 0x2000000 to 0x4000000. That is, the start address of the first guest OS area is 0x2000000, and the end address of first guest OS area is 0x4000000.

The second guest OS area is an address space ranging from 0x8000000 to 0xa000000. That is, the start address of the second guest OS area is 0x8000000, and the end address of second guest OS area is 0xa000000.

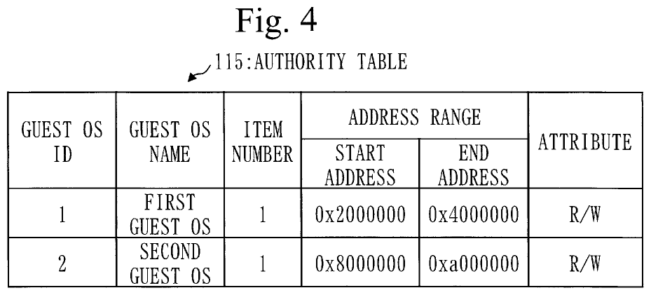

A configuration of the authority table 115 will be described referring to FIG. 4.

The authority table 115 has a field of guest OS identifier (ID), a field of guest OS name, a field of item number, a field of address range, and a field of attribute.

The field of guest OS ID indicates a guest OS ID being an identifier that identifies a guest OS.

The field of guest OS name indicates a guest OS name being the name of the guest OS.

The field of item number indicates a number that identifies each of at least one address space allocated to the guest OS.

The field of address range indicates a range of the address space allocated to the guest OS. More specifically, the field of address range indicates a start address and end address of the address space allocated to the guest OS.

The field of attribute indicates an attribute of access authority. In the field of attribute, R represents read, W represents write, and R/W represents read and write.

The first row of the authority table 115 indicates authority information of the first guest OS 121.

More specifically, the first row of the authority table 115 signifies that the first guest OS 121 identified by guest OS ID “1” has a read/write authority for the address space ranging from 0x2000000 to 0x4000000.

The second row of the authority table 115 indicates authority information of the second guest OS 122.

More specifically, the second row of the authority table 115 signifies that the second guest OS 122 identified by guest OS ID “2” has read/write authority for the address space ranging from 0x8000000 to 0xa000000.

A configuration of the determination code 116 will be described referring to

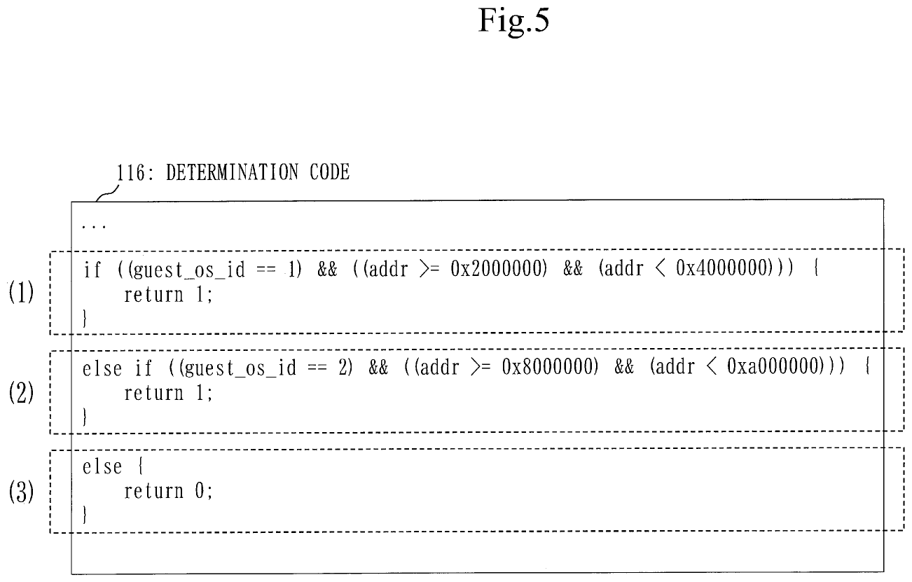

FIG. 5. FIG. 5 illustrates a source code of the determination code 116.

The determination code 116 includes three conditional branch statements corresponding to the authority table 115. Each conditional branch statement includes a conditional expression.

A conditional branch statement (1) is a conditional branch statement corresponding to the first row of the authority table 115. If the guest OS ID is 1 and the address of the memory area to be accessed falls within a range of 0x2000000 to 0x4000000, a return value “1” is outputted by the conditional branch statement (1). The return value “1” signifies presence of access authority.

A conditional branch statement (2) is a conditional branch statement corresponding to the second row of the authority table 115. If the guest OS ID is 2 and the address of the memory area to be accessed falls within a range of 0x8000000 to 0xa000000, a return value “1” is outputted by the conditional branch statement (2).

If none of the condition indicated by the conditional branch statement (1) and the condition indicated by the conditional branch statement (2) holds, a return value “0” is outputted by a conditional branch statement (3). The return value “0” signifies absence of access authority.

The determination code 116 is introduced in the following manner.

First, a conditional branch statement is derived based on the authority table 115.

Subsequently, the conditional branch statement is described using C programming language or another programming language, thereby generating the source code of the determination code 116.

Subsequently, the source code of the determination code 116 is compiled, thereby generating an execution code of the determination code 116.

Then, an execution code of the determination code 116 is concatenated to the execution code of the hypervisor 110.

Note that the execution code of the determination code 116 may be generated using a machine language without generation of the source code of the determination code 116.

A steady state of the information processing device 100 will now be described.

The information processing device 100 is rendered to the steady state as follows.

First, when the power source of the information processing device 100 is turned on, a boot loader is executed, and the execution code of the hypervisor 110 is read from the storage 103 to the memory 102. Thus, the hypervisor area of the memory 102 is rendered to the state illustrated in FIG. 3.

Subsequently, an execution context of the processor 101 changes to the hypervisor 110. The hypervisor 110 reads the image of the first guest OS 121 and the image of the second guest OS 122 from the storage 103 and loads them in the memory 102. Note that the first guest OS 121 and the second guest OS 122 may be loaded from the storage 103 to the memory 102 by the boot loader.

Subsequently, execution of the first guest OS 121 and second guest OS 122 is started. After that, the first application 131 is loaded from the storage 103 to the memory 102 by the first guest OS 121, and the second application 132 and the third application 133 are loaded from the storage 103 to the memory 102. Hence, each guest OS area of the memory 102 is rendered to a state illustrated in FIG. 3.

Then, the first application 131 is executed by the first guest OS 121, and the second application 132 and the third application 133 are executed by the second guest OS 122.

### Description of Operation

An operation of the information processing device 100 corresponds to an access management method. A procedure of the access management method corresponds to a procedure of an access management program.

The access management program is stored in the storage 103, loaded to the memory 102, and executed by the processor 101.

The access management program can be computer readably stored in a non-volatile storage medium such as a magnetic disk, an optical disk, and a flash memory.

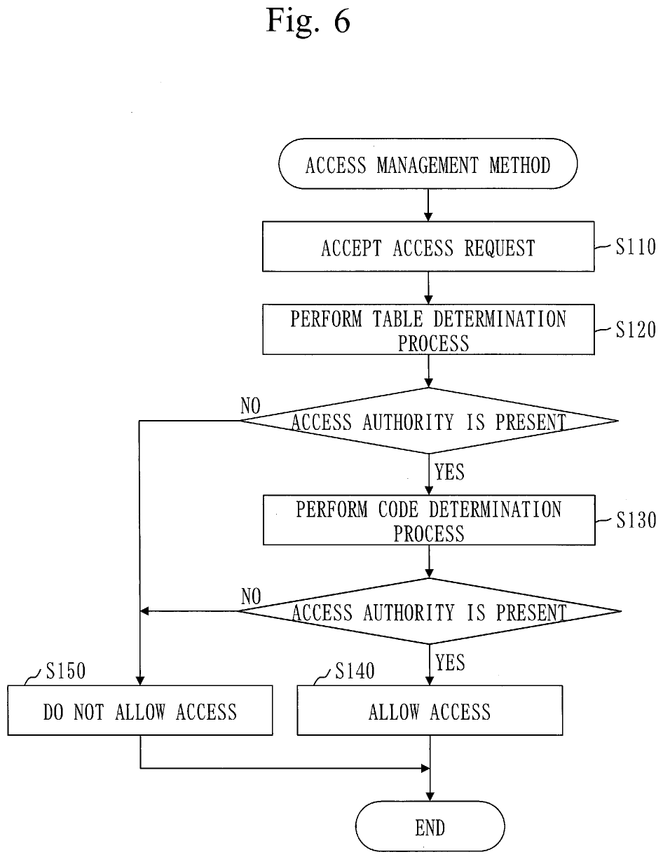

The access management method will be described referring to FIG. 6.

Processing of the access management method is executed when an access request for a system resource occurs.

In step S110, the access control unit 112 accepts an access request.

The access request includes a request source identifier and target resource information.

The request source identifier identifies a request source. The request source is an element that outputted the access request. More specifically, the request source is the first guest OS 121 or second guest OS 122, and the request source identifier is a guest OS ID of either the first guest OS 121 or the second guest OS 122.

The target resource information specifies a target resource. The target resource is a system resource being an access target. More specifically, the target resource is a memory area, and the target resource information is an address of the memory area.

In step S120, the table determination unit 113 performs a table determination process in response to the access request.

The table determination process is a process of determining presence/absence of access authority by referring to the authority table 115.

More specifically, the table determination unit 113 operates as follows.

First, the table determination unit 113 acquires an address range associated with a guest OS ID that is the same as the guest OS ID included in the access request from the authority table 115. The acquired address range is referred to as target address range.

Subsequently, the table determination unit 113 compares an address included in the access request with the target address range.

If the address included in the access request is included in the target address range, the table determination unit 113 determines that access authority is present.

If the address included in the access request is not included in the target address range, the table determination unit 113 determines that access authority is absent.

If it is determined in step S120 that access authority is present, the processing proceeds to step S130.

If it is determined in step S120 that access authority is absent, the processing proceeds to step S150.

In step S130, the code determination unit 114 performs a code determination process in response to the access request.

The code determination process is a process of determining presence/absence of access authority by executing the determination code 116.

More specifically, the code determination unit 114 executes the determination code 116 and refers to a return value from the determination code 116.

If the return value from the determination code 116 is “1”, the code determination unit 114 determines that access authority is present.

If the return value from the determination code 116 is “0”, the code determination unit 114 determines that access authority is absent.

If it is determined in step S130 that access authority is present, the processing proceeds to step S140.

If it is determined in step S130 that access authority is absent, the processing proceeds to step S150.

In step S140, the access control unit 112 allows access to the target resource.

In step S150, the access control unit 112 rejects access to the target resource.

In the access management method (see FIG. 6), the access management unit 111 allows access to the target resource in a case where it is determined by the table determination process (S120) that access authority is present and it is determined by the code determination process (S130) that access authority is present.

Even when the authority table 115 is falsified and an invalid access request occurs, access to the target resource can be rejected by the access management method.

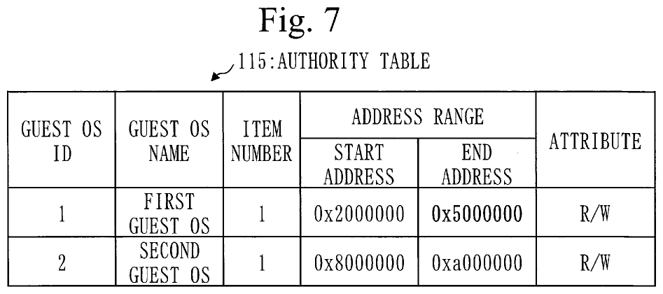

FIG. 7 illustrates the authority table 115 after falsification.

In the authority table 115 of FIG. 7, the end address associated with the first guest OS 121 is falsified from 0x4000000 to 0x5000000.

For example, a security attack committed by an external device via the input/output interface 104, a row hammer attack by an invalid guest OS, or the like falsifies the authority table 115.

Suppose that after the authority table 115 is falsified, an access request for a memory area at 0x45000000 is issued by the first guest OS 121.

In the authority table 115 (see FIG. 7), 0x45000000 is included in an address range associated with the first guest OS 121. Hence, it is determined by the table determination process (S120) that access authority is present.

In the determination code 116 (see FIG. 5), a conditional branch statement corresponding to the access request from the first guest OS 121 is the conditional branch statement (1). In the conditional branch statement (1), 0x45000000 is not included in the address range designated in the conditional expression. Therefore, it is determined by the code determination process (S130) that access authority is absent.

Consequently, while presence of access authority is determined by the table determination process (S120), absence of access authority is determined by the code determination process (S130). Therefore, access to the memory area at 0x45000000 is not allowed.

### Effect of Embodiment 1

In Embodiment 1, determination on an access request is performed by using the determination code 116 derived from the authority table 115, in addition to by conventional determination using the authority table 115. Hence, even when the authority table 115 is falsified by an attack or fraudulence, a correct determination on an access request can be performed.

As the authority table 115 and the determination code 116 are separately arranged in the data area and the code area respectively, it is difficult to falsify both the authority table 115 and the determination code 116 by attacks of the same type. Also, estimation of the storing position in the code area is difficult to perform as compared to estimation of the storing position in the data area. Therefore, Embodiment 1 realizes a stronger security.

The access management unit 111 performs the code determination process (S130) when presence of access authority is determined by the table determination process (S120). Thus, when absence of access authority is determined by the code determination process (S130), the access management unit 111 can determine that the authority table 115 is falsified. Namely, the access management unit 111 can detect falsification of the authority table 115.

### Embodiment 2

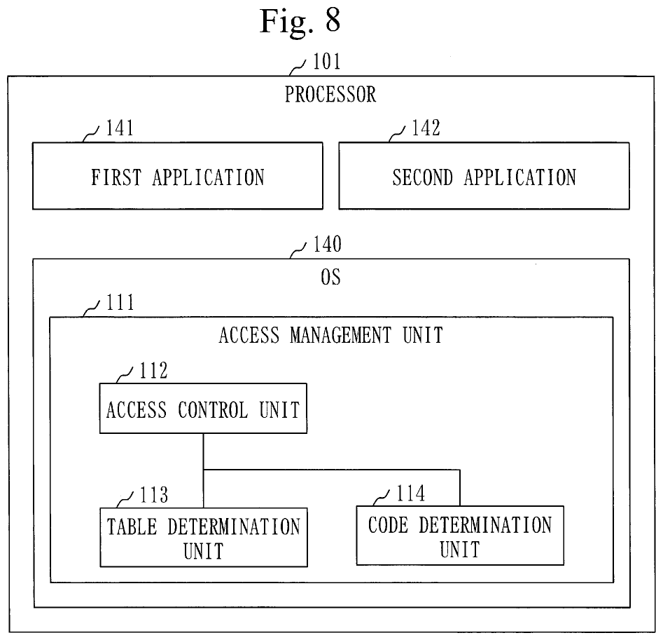

An embodiment in which there is no hypervisor, that is, an embodiment in which one OS is used will be described referring to FIGS. 8 to 11 mainly on differences from Embodiment 1.

### Description of Configuration

A configuration of a processor 101 will be described referring to FIG. 8.

The processor 101 executes an OS 140, a first application 141, and a second application 142.

The processor 101 serves as an access management unit 111 by executing the OS 140.

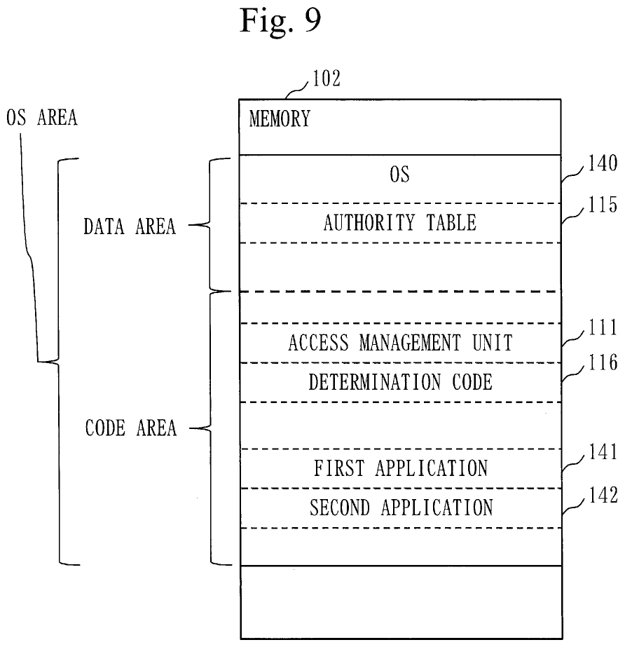

A configuration of a memory 102 will be described referring to FIG. 9.

The memory 102 has an OS area.

The OS area is a memory area for the OS 140.

The OS area has a data area and a code area.

In the data area, an authority table 115 and so on are arranged.

In the code area, the access management unit 111, a determination code 116, the first application 141, the second application 142, and so on are arranged.

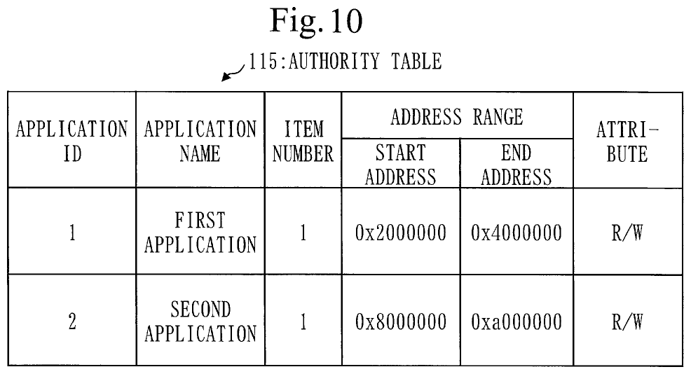

A configuration of the authority table 115 will be described referring to FIG. 10.

The authority table 115 has a field of application ID, a field of application name, a field of item number, a field of address range, and a field of attribute.

The field of application ID indicates an application ID being an identifier that identifies an application.

The field of application name indicates an application name being the name of the application.

The field of item number indicates a number that identifies each of at least one address space which the application can access.

The field of address range indicates a range of the address space which the application can access.

The field of attribute indicates an attribute of the access authority.

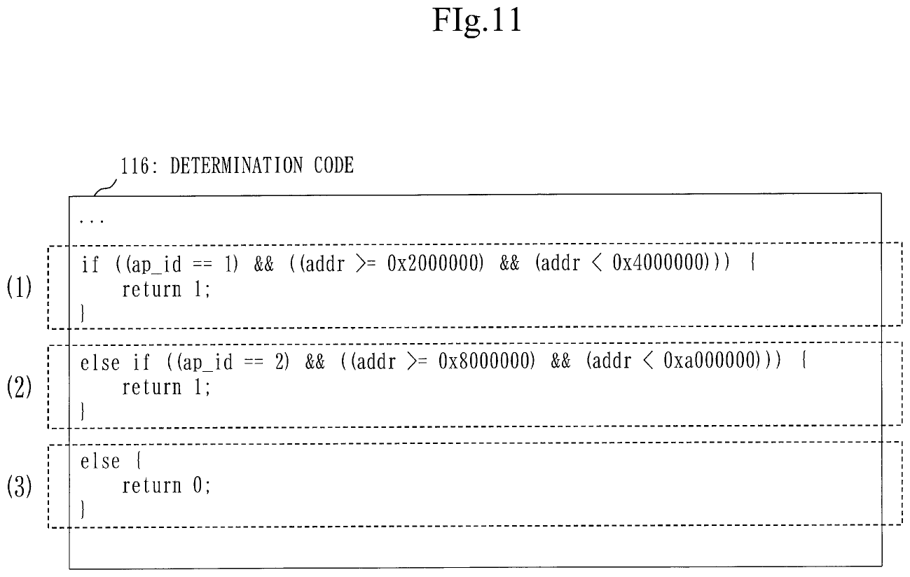

A configuration of the determination code 116 will be described referring to FIG. 11. FIG. 11 illustrates a source code of the determination code 116.

The determination code 116 includes three conditional branch statements corresponding to the authority table 115. Each conditional branch statement includes a conditional expression.

A conditional branch statement (1) is a conditional branch statement corresponding to the first row of the authority table 115. If the application ID is 1 and the address of the memory area to be accessed falls within a range of 0x2000000 to 0x4000000, a return value “1” is outputted by the conditional branch statement (1). The return value “1” signifies that access authority is present.

A conditional branch statement (2) is a conditional branch statement corresponding to the second row of the authority table 115. If the application ID is 2 and the address of the memory area to be accessed falls within a range of 0x8000000 to 0xa000000, a return value “1” is outputted by the conditional branch statement (2).

If none of the condition indicated by the conditional branch statement (1) and the condition indicated by the conditional branch statement (2) holds, a return value “0” is outputted by a conditional branch statement (3). The return value “0” signifies that access authority is absent.

### Description of Operation

An access management method is the same as that in Embodiment 1 (see FIG. 6).

That is, the access management unit 111 allows access to the target resource in the case where it is determined by the table determination process (S120) that access authority is present and it is determined by the code determination process (S130) that access authority is present.

### Effect of Embodiment 2

In Embodiment 2, access authority can be multiplexed for an application in an ordinary OS as well. Even when the authority table 115 is falsified by an attack or fraudulence, a correct determination on an access request can be performed.

### Embodiment 3

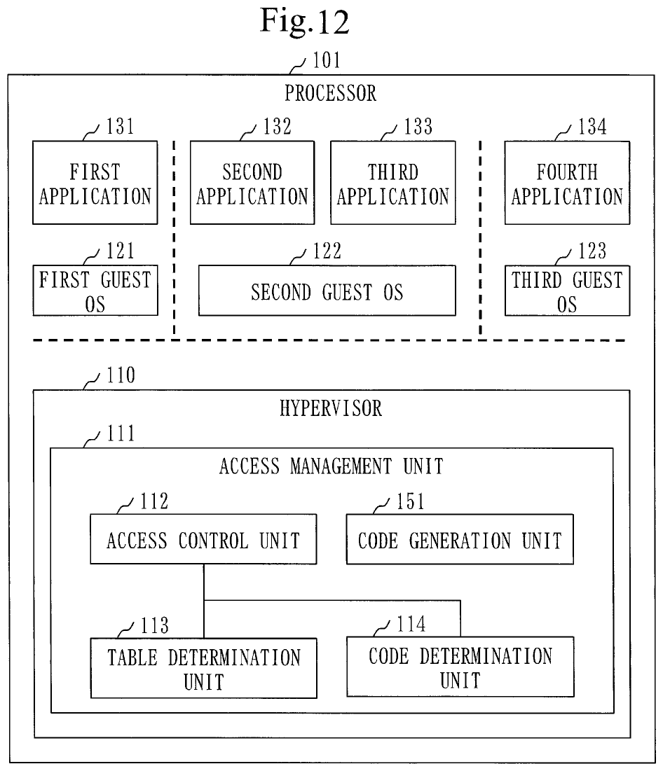

An embodiment in which a determination code 116 is updated when an authority table 115 is updated will be described referring to FIGS. 12 to 17 mainly on differences from Embodiment 1.

### Description of Configuration

A configuration of a processor 101 will be described referring to FIG. 12.

The processor 101 executes a third guest OS 123 and a fourth application 134 in addition to the elements described in Embodiment 1 (see FIG. 2).

The third guest OS 123 is executed by using a hardware resource allocated by a hypervisor 110.

The fourth application 134 is executed by using a hardware resource allocated to the third guest OS 123.

The hypervisor 110 is provided with an access management unit 111.

The access management unit 111 is provided with a code generation unit 151 in addition to the elements described in Embodiment 1 (see FIG. 2).

The code generation unit 151 generates the determination code 116 corresponding to the authority table 115.

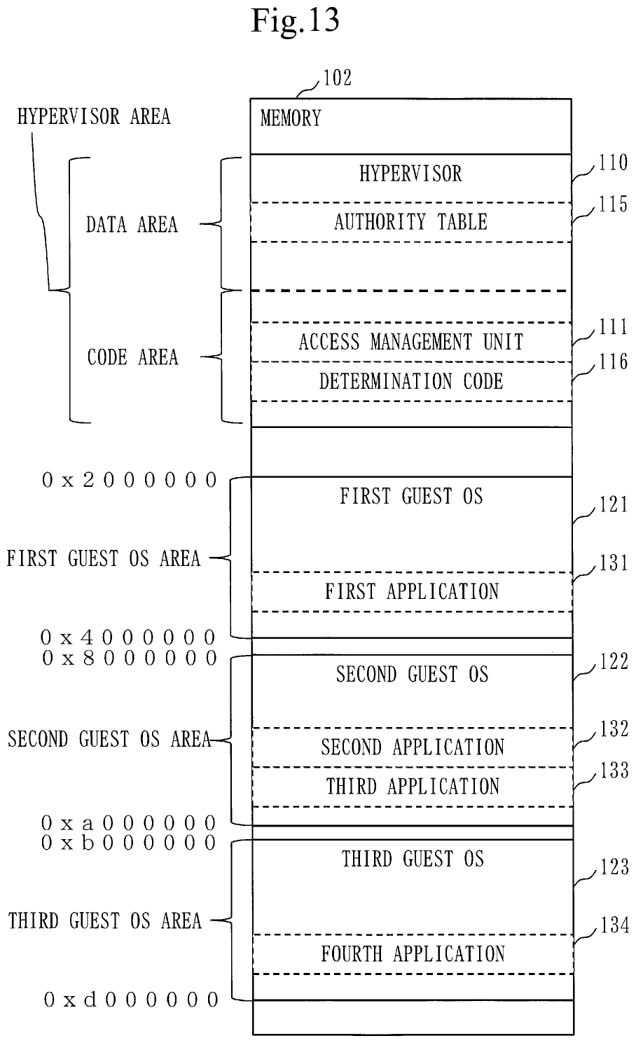

A configuration of a memory 102 will be described referring to FIG. 13.

The memory 102 has a third guest OS area in addition to the memory areas described in Embodiment 1 (see FIG. 3).

The third guest OS area is a memory area for the third guest OS 123. More specifically, the third guest OS area is an address space ranging from 0xb000000 to 0xd000000. That is, the start address of the third guest OS area is 0xb000000, and the end address of third guest OS area is 0xd000000.

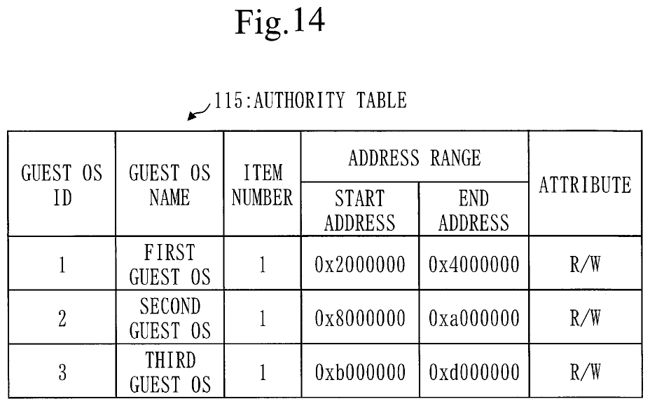

A configuration of the authority table 115 will be described referring to FIG. 14.

The authority table 115 includes the third row indicating the authority information of the third guest OS 123, in addition to the rows described in Embodiment 1 (see FIG. 4).

More specifically, the third row of the authority table 115 signifies that the third guest OS 123 identified by the guest OS ID “3” has read/write authority for the address space ranging from 0xb000000 to 0xd000000.

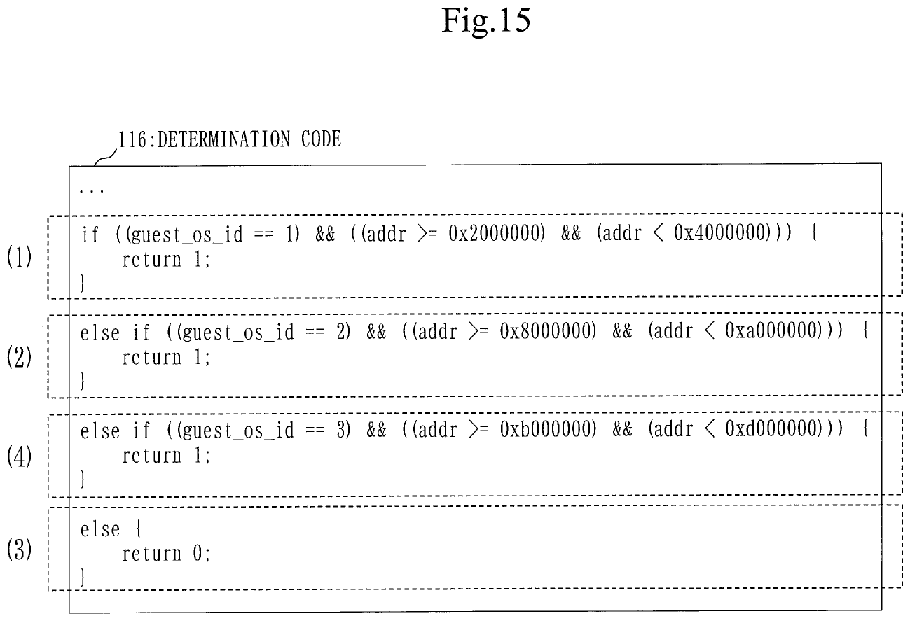

A configuration of the determination code 116 will be described referring to FIG. 15.

The determination code 116 includes a conditional branch statement (4) in addition to the conditional branch statements described in Embodiment 1 (see FIG. 5).

The conditional branch statement (4) is a conditional branch statement corresponding to the third row of the authority table 115. If the guest OS ID is 3 and the address of the memory area to be accessed falls within a range of 0xb000000 to 0xd000000, a return value “1” is outputted by the conditional branch statement (4). The return value “1” signifies presence of access authority.

### Description of Operation

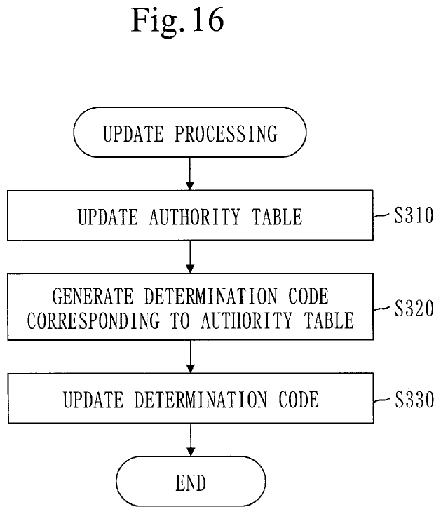

Update processing will be described referring to FIG. 16.

Update processing is processing executed when updating the authority table 115.

In step S310, the hypervisor 110 updates the authority table 115. The authority table 115 is updated in the same manner as in the conventional case.

More specifically, the hypervisor 110 updates the authority table 115 from a state of FIG. 4 to a state of FIG. 14 in order to add the third guest OS 123.

In step S320, the code generation unit 151 generates the determination code 116 corresponding to the authority table 115.

More specifically, the code generation unit 151 generates an execution code of the determination code 116 as follows.

First, the code generation unit 151 generates a source code of the determination code 116 based on the authority table 115.

Then, the code generation unit 151 generates an execution code of the determination code 116 by compiling the source code of the determination code 116.

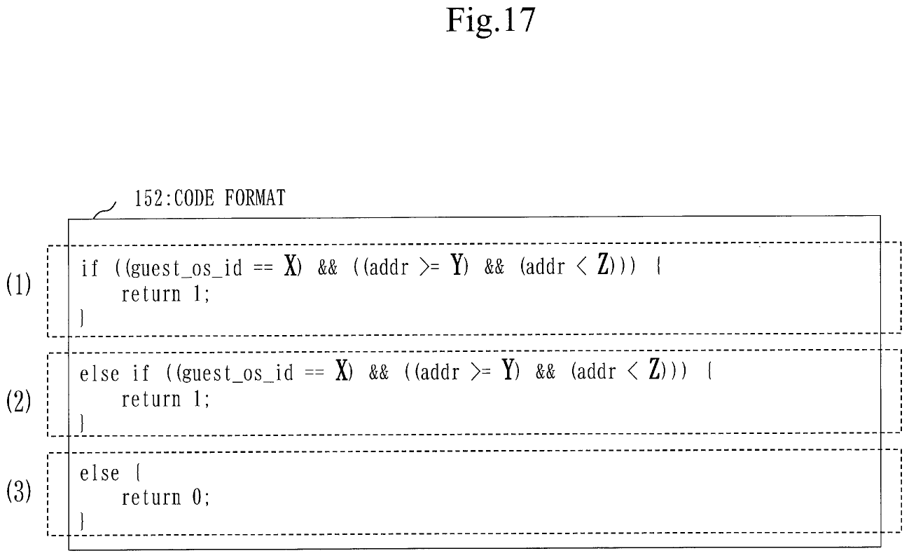

More specifically, the code generation unit 151 generates the source code of the determination code 116 illustrated in FIG. 15 by using the authority table 115 of FIG. 14 and a code format 152 of FIG. 17.

The code format 152 will be described referring to FIG. 17.

The code format 152 is a format for generating the source code of the determination code 116.

The code format 152 includes three format statements.

A format statement (1) is a format of a conditional branch statement corresponding to the first row of the authority table 115.

A format statement (2) is a format of a conditional branch statement corresponding to an nth row of the authority table 115 where n is an integer of 2 or more.

Each of the format statement (1) and the format statement (2) includes a variable X, a variable Y, and a variable Z.

The variable X is a variable to which the guest OS ID is assigned.

The variable Y is a variable to which the start address is assigned.

The variable Z is a variable to which the end address is assigned.

A format statement (3) is a conditional branch statement attached to the end of the source code of the determination code 116.

First, using the format statement (1), the code generation unit 151 generates a conditional branch statement corresponding to the first row of the authority table 115.

That is, the code generation unit 151 assigns a guest OS ID included in the first row of the authority table 115 to the variable X included in the format statement (1). Furthermore, the code generation unit 151 assigns a start address included in the first row of the authority table 115 to the variable Y included in the format statement (1). Furthermore, the code generation unit 151 assigns an end address included in the first row of the authority table 115 to the variable Z included in the format statement (1).

Subsequently, using the format statement (2), the code generation unit 151 generates a conditional statement corresponding to the nth row of the authority table 115. That is, the code generation unit 151 assigns a guest OS ID included in the nth row of the authority table 115 to the variable Y included in the format statement (2). Furthermore, the code generation unit 151 assigns a start address included in the nth row of the authority table 115 to the variable X included in the format statement (2). Furthermore, the code generation unit 151 assigns an end address included in the nth row of the authority table 115 to the variable Z included in the format statement (2).

Then, the code generation unit 151 attaches the format statement (3) to the end of the source code of the determination code 116.

Back to step S16, step S330 will be described.

In step S330, the hypervisor 110 updates the determination code 116 stored in the memory 102 to a determination code 116 corresponding to the authority table 115. That is, the hypervisor 110 replaces the determination code 116 stored in the memory 102 by the determination code 116 generated in step S320.

### Supplement to Embodiment 3

The memory 102 reserves in the code area a memory area having an area size corresponding to the upper-limit number of request sources, as a memory area for the determination code 116.

More specifically, the user defines the maximum number of request sources and estimates the maximum size of the determination code 116 based on the maximum number of request sources. The maximum size of the determination code 116 is the maximum value of an area size necessary for arranging the execution code of the determination code 116. The user then sets the maximum size of the determination code 116 in the information processing device 100, and the memory 102 reserves a memory area having the maximum size of the determination code 116 in the code area.

If the execution code of the determination code 116 can be dynamically linked to the hypervisor 110, the source code of the determination code 116 may be described in a language other than C programming language.

If a dynamic change is a perpetual change, the execution code (binary) of the determination code 116 is stored in a storage 103 and maintains a format that enables the execution code to be used after reboot.

Embodiment 3 may be applied to Embodiment 2.

That is, the access management unit 111 in Embodiment 2 may be provided with a code generation unit 151.

### Effect of Embodiment 3

By Embodiment 3, the determination code 116 can be generated dynamically in response to update of the authority table 115. Hence, access authority corresponding to the number of guest OSs can be set even after the hypervisor 110 starts operation.

### Embodiment 4

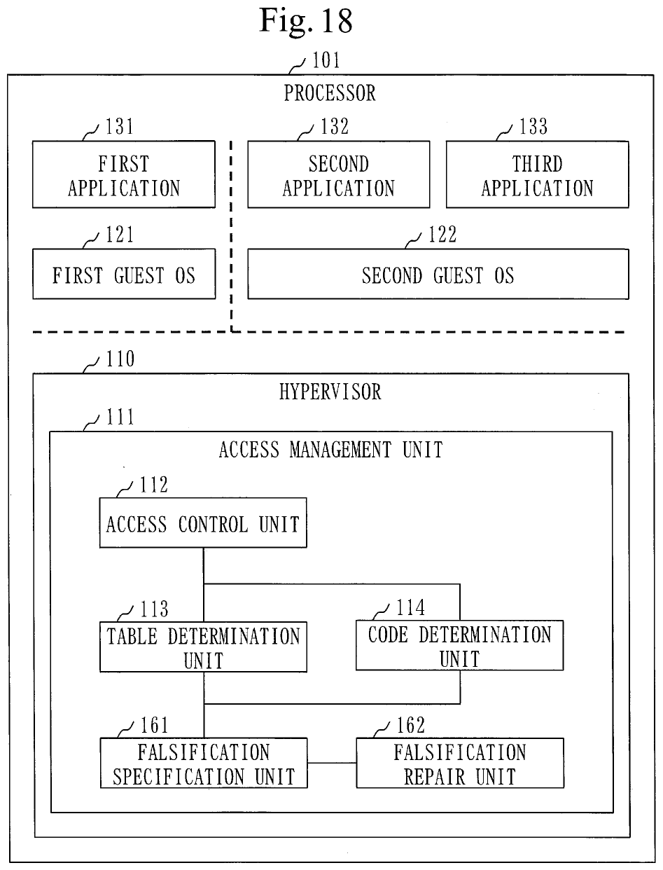

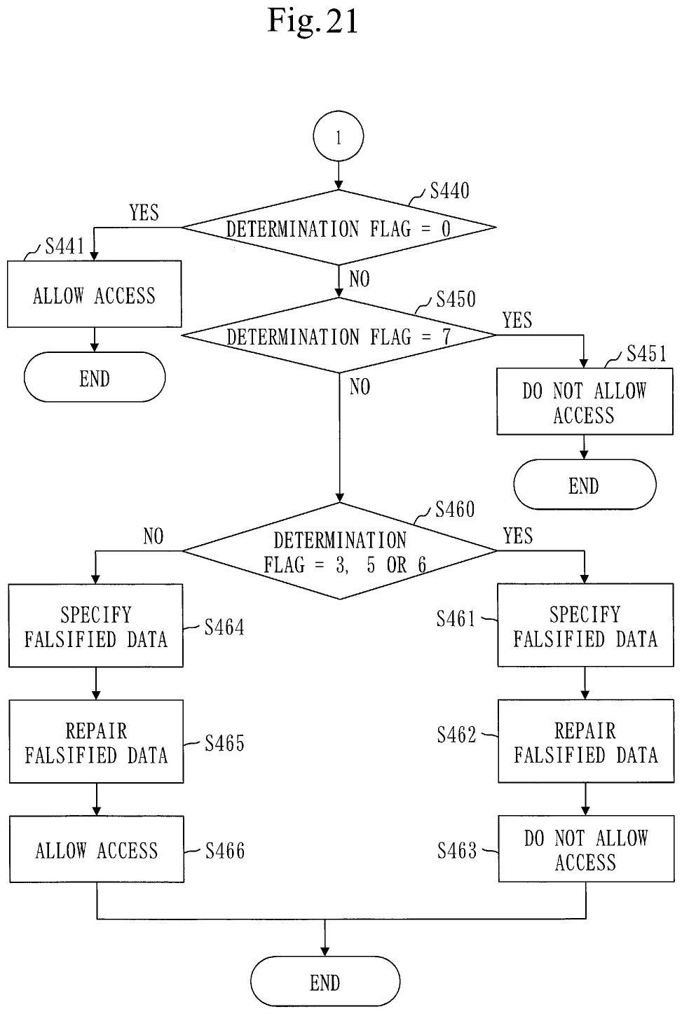

An embodiment in which, in the case where data of either an authority table 115 or a determination code 116 is falsified, the falsified data is repaired will be described referring to FIGS. 18 and 21 mainly on differences from Embodiment 1.

### Description of Configuration

A configuration of a processor 101 will be described referring to FIG. 18.

The processor 101 executes a hypervisor 110.

The hypervisor 110 is provided with an access management unit 111.

The access management unit 111 is provided with a falsification specification unit 161 and a falsification repair unit 162 in addition to the elements described in Embodiment 1 (see FIG. 2).

The functions of the falsification specification unit 161 and falsification repair unit 162 will be described later.

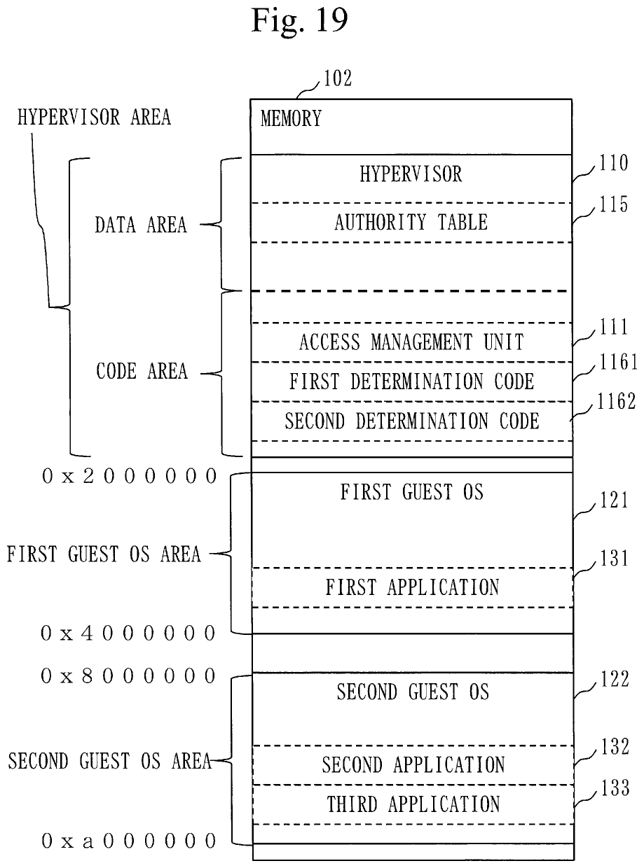

A configuration of a memory 102 will be described referring to FIG. 19.

The memory 102 has a hypervisor area. The hypervisor area has a data area and a code area.

In the code area, the access management unit 111, a first determination code 1161, a second determination code 1162, and so on are arranged.

The first determination code 1161 and the second determination code 1162 are the same as the determination code 116 described in Embodiment 1 (see FIG. 5).

### Description of Operation

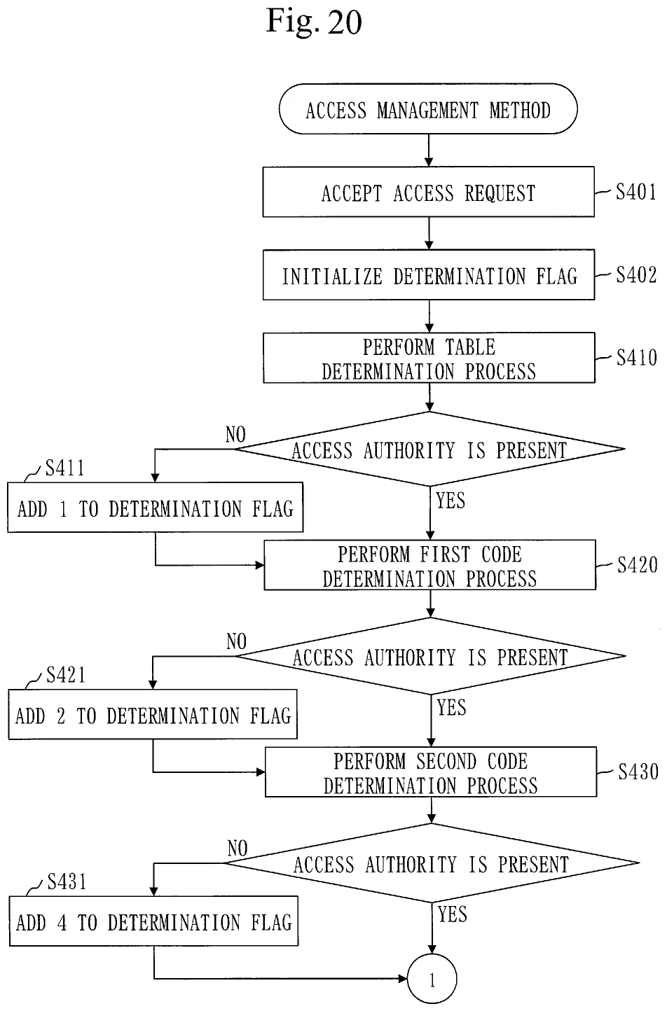

An access management method will be described referring to FIGS. 20 and 21.

In step S401 (see FIG. 20), an access control unit 112 accepts an access request.

In step S402, the access control unit 112 initializes a determination flag.

The determination flag is a flag having 3 bits. In the determination flag, the first bit is used as a bit expressing the result of a table determination process (S410), the second bit is used as a bit expressing the result of a first code determination process (S420), and the third bit is used as a bit expressing the result of a second code determination process (S430). A bit value “0” signifies that presence of access authority is determined, and a bit value “1” signifies that absence of access authority is determined.

More specifically, the access control unit 112 assigns 0 to the determination flag. As a result, all of the first bit, second bit, and third bit in the determination flag are 0.

In step S410, a table determination unit 113 determines presence/absence of access authority by a table determination process.

If it is determined that access authority is present, the processing proceeds to step S420.

If it is determined that access authority is absent, the processing proceeds to step 411.

In step S411, the access control unit 112 adds 1 to the determination flag.

As a result, the first bit of the determination flag changes from 0 to 1.

In step S420, the code determination unit 114 determines presence/absence of access authority by a first code determination process.

The first code determination process is a code determination process of determining presence/absence of access authority by executing the first determination code 1161.

If it is determined that access authority is present, the processing proceeds to step S430.

If it is determined that access authority is absent, the processing proceeds to step S421.

In step S421, the access control unit 112 adds 2 to the determination flag.

As a result, the second bit of the determination flag changes from 0 to 1.

In step S430, the code determination unit 114 determines presence/absence of access authority by the second code determination process.

The second code determination process is a code determination process of determining presence/absence of access authority by executing the second determination code 1162.

If it is determined that access authority is present, the processing proceeds to step S441 (see FIG. 21).

If it is determined that access authority is absent, the processing proceeds to step S431.

In step S431, the access control unit 112 adds 4 to the determination flag.

As a result, the third bit of the determination flag changes from 0 to 1.

After step S431, the processing proceeds to step S441 (see FIG. 21).

In step S440, the access control unit 112 determines whether the determination flag is 0. A flag value “0” signifies that presence of access authority is determined in every determination process of the table determination process (S410), first code determination process (S420), and second code determination process (S430).

If the determination flag is 0, the processing proceeds to step S441.

If the determination flag is not 0, the processing proceeds to step S450.

In step S441, the access control unit 112 allows access to the target resource.

In step S450, the access control unit 112 determines whether the determination flag is 7. A flag value “7” signifies that absence of access authority is determined in every determination process of the table determination process (S410), first code determination process (S420), and second code determination process (S430).

If the determination flag is 7, the processing proceeds to step S451.

If the determination flag is not 7, the processing proceeds to step S460.

In step S451, the access control unit 112 does not allow access to the target resource.

If the processing proceeds to step S460, the determination flag is neither 0 nor 7.

That is, the result of any one determination process among the table determination result (S410), first code determination result (S420), and second code determination result (S430) does not match the result of the other determination processes.

In this case, data of any one among the authority table 115, first determination code 1161, and second determination code 1162 has been falsified.

In step S460, the access control unit 112 determines whether the determination flag is one of 3, 5, and 6.

If the determination flag is one of 3, 5, and 6, the processing proceeds to step S461.

If the determination flag is one of 1, 2, and 4, the processing proceeds to step S464.

In step S461, the falsification specification unit 161 specifies falsified data among the authority table 115, the first determination code 1161, and the second determination code 1162 based on the determination flag.

More specifically, the falsification specification unit 161 specifies a bit to which 0 is assigned, among 3 bits of the determination flag.

If the first bit is 0, the falsified data is the authority table 115.

If the second bit is 0, the falsified data is the first determination code 1161.

If the third bit is 0, the falsified data is the second determination code 1162.

In step S642, the falsification repair unit 162 repairs the falsified data based on data other than the falsified data among the authority table 115, the first determination code 1161, and the second determination code 1162.

If the falsified data is the authority table 115, the falsification repair unit 162 repairs the authority table 115 by correcting the address range being set in the authority table 115 in accordance with the address range being set in the conditional expressions of the first determination code 1161 and second determination code 1162.

If the falsified data is the first determination code 1161, the falsification repair unit 162 repairs the first determination code 1161 by correcting the address range being set in the conditional expression of the first determination code 1161 in accordance with the address range being set in the authority table 115.

If the falsified data is the second determination code 1162, the falsification repair unit 162 repairs the second determination code 1162 by correcting the address range being set in the conditional expression of the second determination code 1162 in accordance with the address range being set in the authority table 115.

In step S463, the access control unit 112 does not allow access to the target resource.

In step S464, the falsification specification unit 161 specifies the falsified data among the authority table 115, the first determination code 1161, and the second determination code 1162 based on the determination flag.

More specifically, the falsification specification unit 161 specifies a bit to which 1 is assigned among 3 bits of the determination flag.

If the first bit is 1, the falsified data is the authority table 115.

If the second bit is 1, the falsified data is the first determination code 1161.

If the third bit is 1, the falsified data is the second determination code 1162.

In step S645, the falsification repair unit 162 repairs the falsified data based on data other than the falsified data among the authority table 115, the first determination code 1161, and the second determination code 1162.

Repair is done in the same manner as in step S462.

In step S466, the access control unit 112 allows access to the target resource.

### Supplement to Embodiment 4

A processing time necessary for determination of access authority is presumed to be sufficiently short. Therefore, to falsify two or more pieces of data among the authority table 115, the first determination code 1161, and the second determination code 1162 by an attack on authority information within a time shorter than the processing time necessary for determination of access authority is presumed to be difficult.

From the viewpoint of leveling the entire calculation amount between the first determination code 1161 and the second determination code 1162, it may be possible in the first determination code 1161 to describe the conditional branch statement (2) after the conditional branch statement (1), as in FIG. 5, and it may be possible in the second determination code 1162 to describe the conditional branch statement (1) after the conditional branch statement (2).

Conditional branching in step S440, step S450, and step S460 is equivalent to performing a process of correcting a 1-bit error in the 3-bit determination flag.

Embodiment 4 may be applied to Embodiment 2 and Embodiment 3.

That is, the access management unit 111 in Embodiment 2 may be provided with a falsification specification unit 161 and a falsification repair unit 162.

The access management unit 111 in Embodiment 3 may be provided with a falsification specification unit 161 and a falsification repair unit 162.

### Effect of Embodiment 4

With Embodiment 4, it is possible to detect falsification of any data among the authority table 115, the first determination code 1161, and the second determination code 1162, and it is possible to correct the falsified data.

### Supplement to Embodiments

In the embodiments, the function of the information processing device 100 may be implemented by hardware.

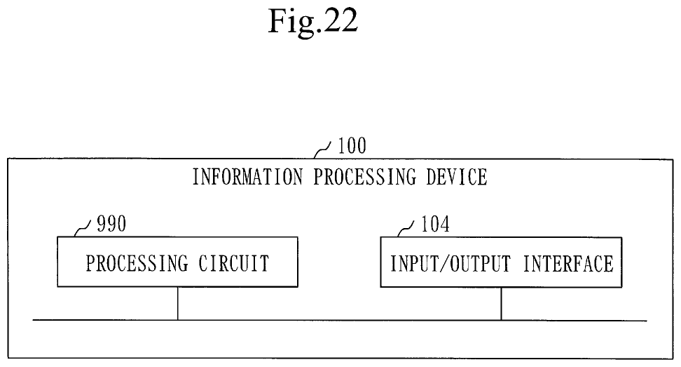

FIG. 22 illustrates a configuration of a case where the function of the information processing device 100 is implemented by hardware.

The information processing device 100 is provided with a processing circuit 990. The processing circuit 990 is also called processing circuitry.

The processing circuit 990 is a dedicated electronic circuit that implements the processor 101, the memory 102, and the storage 103.

For example, the processing circuit 990 is a single circuit, a composite circuit, a programmed processor, a parallel-programmed processor, a logic IC, a GA, an ASIC, or an FPGA; or a combination of them. GA is an abbreviation for Gate Array. ASIC is an abbreviation for Application Specific Integrated Circuit. FPGA is an abbreviation for Field Programmable Gate Array.

The information processing device 100 may be provided with a plurality of processing circuits that replace the processing circuit 990. The plurality of processing circuits share the role of the processing circuit 990.

The embodiments exemplify preferred embodiments and are not intended to limit the technical scope of the present invention. Each embodiment may be practiced partly or in combination with another embodiment. The procedures described using flowcharts or the like may be changed where necessary.

### REFERENCE SIGNS LIST

100: information processing device; 101: processor; 102: memory; 103: storage; 104: input/output interface; 110: hypervisor; 111: access management unit; 112: access control unit; 113: table determination unit; 114: code determination unit; 115: authority table; 116: determination code; 1161: first determination code; 1162: second determination code; 121: first guest OS; 122: second guest OS; 123: third guest OS; 131: first application; 132: second application; 133: third application; 134: fourth application; 140: OS; 141: first application; 142: second application; 151: code generation unit; 152: code format; 161: falsification specification unit; 162: falsification repair unit; 990: processing circuit

1. An information processing device comprising:
processing circuitry
to perform a table determination process, when an access request for a system resource occurs, of determining presence/absence of access authority by referring to an authority table including authority information to identify presence/absence of the access authority for the system resource;
to perform a code determination process, when the access request occurs, of determining presence/absence of the access authority by executing a determination code to determine presence/absence of the access authority; and
to allow access to the system resource in a case where it is determined by the table determination process that the access authority is present and it is determined by the code determination process that the access authority is present.

2. The information processing device according to claim 1,
the information processing device comprising a memory having a data area and a code area,
wherein the authority table is arranged in the data area and the determination code is arranged in the code area.

3. The information processing device according to claim 2,
wherein the memory has a hypervisor area being a memory area for a hypervisor and has the data area and the code area in the hypervisor area.

4. The information processing device according to claim 2,
wherein the memory has an operation system area being a memory area for an operation system and has the data area and the code area in the operation system area.

5. The information processing device according to claim 2,
wherein the memory reserves, in the code area, a memory area having an area size corresponding to an upper-limit number of request sources, as a memory area for the determination code.

6. The information processing device according to claim 1, where in the processing circuitry generates the determination code based on the authority table.

7. The information processing device according to claim 1,
wherein the processing circuitry performs, as the code determination process, a first code determination process and a second code determination process, the first code determination process determining presence/absence of the access authority by executing a first determination code, the second code determination process determining presence/absence of the access authority by executing a second determination code, and
wherein the processing circuitry determines allowance/rejection of access to the system resource based on a result of the table determination process, a result of the first code determination process, and a result of the second determination code.

8. The information processing device according to claim 7, wherein the processing circuitry which, when any data among the authority table, the first determination code, and the second determination code is falsified, specifies falsified data among the authority table, the first determination code, and the second determination code based on the result of the table determination process, the result of the first code determination process, and the result of the second determination code.

9. The information processing device according to claim 8, wherein the processing circuitry repairs the falsified data based on data other than the falsified data among the authority table, the first determination code, and the second determination code.

10. The information processing device according to claim 7,
wherein the processing circuitry assigns the result of the table determination process to a first bit among 3 bits, the result of the first code determination process to a second bit among the 3 bits, and the result of the second code determination process to the third bit among the 3 bits, and determines allowance/rejection of access to the system resource based on the 3 bits.

11. A non-transitory computer readable medium storing an access management program which causes a computer to execute:
a table determination process, when an access request for a system resource occurs, of determining presence/absence of access authority by referring to an authority table including authority information to identify presence/absence of the access authority for the system resource;
a code determination process, when the access request occurs, of determining presence/absence of the access authority by executing a determination code to determine presence/absence of the access authority; and
an access control process of allowing access to the system resource in a case where it is determined by the table determination process that the access authority is present and it is determined by the code determination process that the access authority is present.
